(19) United States
(12) Patent Application Publication
(10) Pub. No.: US 2016/0065978 A1
(43) Pub. Date: Mar. 3, 2016

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Saku Hiwatashi, Tokyo (JP)

(21) Appl. No.: 14/835,085

(22) Filed: Aug. 25, 2015

(30) Foreign Application Priority Data
Aug. 28, 2014 (JP) 2014-174495

(51) Int. Cl. H04N 19/31; H04N 19/503; H04N 19/172; H04N 19/146

(52) U.S. Cl. CPC H04N 19/31; H04N 19/146; H04N 19/503; H04N 19/172

(57) ABSTRACT

An image processing apparatus, which is configured to code a frame included in a moving image with use of a temporal hierarchal layer, includes an acquisition unit configured to acquire information regarding the temporal hierarchal layer corresponding to the frame as a coding target, and a coding unit configured to code the frame of the coding target with use of a first coding parameter that causes a bit rate after the frame is coded to be equal to or lower than a first bit rate corresponding to the temporal hierarchal layer acquired by the acquisition unit, or a second coding parameter that causes the bit rate after the frame is coded to match a second bit rate higher than the first bit rate, based on the information regarding the temporal hierarchal layer acquired by the acquisition unit.

### BACKGROUND OF THE INVENTION

1. Field of the Invention

The present invention relates to an image processing apparatus, an image processing method, and a storage medium, and, in particular, to an image processing technique using a temporal hierarchical identifier.

2. Description of the Related Art

There is known the High Efficiency Video Coding (HEVC) coding method (hereinafter referred to as HEVC) as a coding method for compressively recording a moving image. In HEVC, scalable video coding, by which the moving image is coded hierarchically from a low-quality image to a high-quality image, is employed as an extended specification. The scalable video coding may be classified into spatial scalability, temporal scalability, and Signal-to-Noise Ratio (SNR) scalability in terms of a type of hierarchized information. The temporal scalability refers to a technique for constructing a hierarchy in correspondence with a change in a temporal range (scale), i.e., the number of frames per unit time (a frame rate) in the case of the image coding. Then, the frame rate can be adjusted by extracting a part of data that is structured in the hierarchy. In other words, the frame rate can be flexibly switched in consideration of a restriction varying depending on an environment, such as network transmission and reproduction (decoding) processing, by creating a moving image capable of realizing a plurality of frame rates.

In HEVC, the standard thereof specifies coding each frame in the moving image while assigning a temporal hierarchical identifier (a Temporal ID), which indicates information for identifying each hierarchical layer in the temporal hierarchy, to this frame, to realize the hierarchical coding corresponding to the above-described temporal scalability. The frame in each hierarchical layer is configured to be reproducible with reference to a frame provided with a value of the set Temporal ID and a frame provided with a smaller value than the value of the set Temporal ID. Then, the temporal hierarchical layer is selected and the frame is reproduced (i.e., decoded and displayed) based on this Temporal ID.

Now, a relationship between the Temporal ID and the frame rate of the selectively reproducible moving image will be described with reference to FIG. 6A. FIG. 6A illustrates frames including an intra frame (I frame), a predicted frame (a P frame), and a bi-directional predicted frame (a B frame) in a state of being sorted into four hierarchical layers. A Temporal ID=3, a Temporal ID=2, a Temporal ID=1, and a Temporal ID=0 are assigned to the frames placed in the individual hierarchical layers illustrated in FIG. 6A from the top, respectively. In the example illustrated in FIG. 6A, moving images having four different kinds of frame rates can be created by selecting the frames coded with the Temporal ID being assigned thereto in this manner based on the Temporal ID at the time of transmission and at the time of reproduction. For example, if the Temporal ID=0 (a frame group 604 in FIG. 6A) is selected alone, the created moving image has a frame rate of 7.5 Frames Per Second (FPS). Further, if the Temporal IDs=0 and 1 (a frame group 603 in FIG. 6A) are selected, the created moving image has a frame rate of 15 FPS. Further, if the Temporal IDs=0, 1, and 2 (a frame group 602 in FIG. 6A) are selected, the created moving image has a frame rate of 30 FPS. Then, if all the hierarchical layers of the Temporal IDs=0, 1, 2, and 3 (a frame group 601 in FIG. 6A) are selected, the created moving image has a frame rate of 60 FPS. In this manner, the frame rate when the moving image is reproduced can be selected on a reproduction side based on the Temporal ID.

Next, there is a technique for assigning a priority level of processing between frames to each frame in the moving image, and transmitting the frame based on this priority level, as a technique for controlling the frame rate on a transmission side (see Japanese Patent No. 3519722). According to the technique discussed in Japanese Patent No. 3519722, the priority level of the processing corresponding to each frame is assigned in the following manner. The priority level of the processing corresponding to each frame is assigned according to a frame prediction method (hereinafter referred to as a frame type), such as an intra-reference frame (hereinafter referred to as the I frame), an inter-reference frame (hereinafter referred to as the P frame), and a bi-directional inter-reference frame (hereinafter referred to as the B frame). How high the priority level should be is determined based on a dependency relationship between the frame and a frame used as a prediction image. More specifically, the I frame may be referred to from both the P frame and the B frame, and therefore is provided with a highest priority level among the above-described three frame types. The B frame is not used as a reference image, and therefore is provided with a lowest priority level. Then, the P frame may be referred to from the B frame, and therefore is provided with an intermediate priority level lower than the priority level assigned to the I frame and higher than the priority level assigned to the B frame.

Then, according to the technique discussed in Japanese Patent No. 3519722, bit rate control is performed based on a transmission state of a communication path by temporarily removing frames (i.e., reducing the frame rate) based on the priority level assigned to each of the frames. More specifically, the frames are transmitted after frames provided with a low priority level lower than a threshold value are removed according to the transmission state of the communication path (i.e., an effective bit rate). The transmitted frames are selected based on the priority level assigned to each of the frames and the transmission state of the communication path with use of the threshold value, like (1) transmitting all of the frames, (2) transmitting only the frames of [the priority level: high] (the I frame) and [the priority level: intermediate] (the P frame), and (3) transmitting only the frames of [the priority level: high] (the I frame).

According to the technique discussed in Japanese Patent No. 3519722, the transmission frame rate is controlled by cutting off the frames provided with the lower priority level based on the priority level assigned based on the frame type corresponding to each of the frames and the transmission state of the communication path, when a transmitted bit rate likely exceeds the effective transmission rate. Then, the number of priority levels is limited based on the number of kinds of the frame types.

Therefore, the following problem arises in a case where the frame rate is selected based on the Temporal ID to reproduce the moving image data for which the frame rate is controlled on the transmission side as discussed in Japanese Patent No. 3519722. For example, suppose that, as illustrated in FIG. 6B, the B frame is placed in a hierarchical layer of the Temporal ID=1, and the priority level is set to each of the frame types in such a manner that [the priority level: high], [the priority level: intermediate], and [the priority level: low] are set to the I frame, the P frame, and the B frame, respectively. In this case, the method discussed in Japanese Patent No. 3519722 may lead to a preferential removal of the B frame group contained in the hierarchical layer of the Temporal ID=1 at the time of the transmission, since its priority level is lower than the priority level assigned to the P frame group contained in a hierarchical layer of the Temporal ID=2. Therefore, this example results in an inability to normally reproduce the frames at 30 FPS indicated in correspondence with a frame group 612 in FIG. 6B due to the removal of the B frame provided with the Temporal ID=1.

Further, as illustrated in FIG. 6B, each of frames 614 to 617 in a frame group 611 cannot be reproduced due to its dependency on the B frame in the frame group 612, which is the removed frame group, as the reference frame. In this manner, in the case where the frame provided with the Temporal ID=2 refers to the removed frame provided with the Temporal ID=1, a predetermined frame provided with the Temporal ID=2 cannot be also reproduced. Therefore, in such a case, this example also results in an inability to normally reproduce the frames at 60 FPS indicated in correspondence with the frame group 611. In this manner, the coding according to the method discussed in Japanese Patent No. 3519722 may be unable to control the frame rate to a desired frame rate in some cases.

As described above, the use of the method discussed in Japanese Patent No. 3519722 is difficult to control the moving image data coded by the temporal scalability coding based on the Temporal ID to be a desired bit rate and frame rate.

### SUMMARY OF THE INVENTION

According to an aspect of the present invention, an image processing apparatus configured to code a frame included in a moving image with use of a temporal hierarchal layer, includes an acquisition unit configured to acquire information regarding the temporal hierarchal layer corresponding to the frame of a coding target, and a coding unit configured to code the frame of the coding target with use of a first coding parameter that causes a bit rate after the frame is coded to be equal to or lower than a first bit rate corresponding to the temporal hierarchal layer acquired by the acquisition unit, or a second coding parameter that causes the bit rate after the frame is coded to match a second bit rate higher than the first bit rate, based on the information regarding the temporal hierarchal layer acquired by the acquisition unit.

According to the present invention, it is possible to realize scalable bit rate control and frame rate control of the coded moving image data in consideration of the effective transmission rate of the communication path and the temporal hierarchical identifier (the Temporal ID).

Further features of the present invention will become apparent from the following description of exemplary embodiments with reference to the attached drawings.

### BRIEF DESCRIPTION OF THE DRAWINGS

FIG. 1 is a flowchart illustrating coding processing according to a first exemplary embodiment.

FIG. 2 illustrates each frame rate layer according to the first exemplary embodiment.

FIG. 3 is a flowchart illustrating coding processing according to a second exemplary embodiment.

FIG. 4 illustrates each frame rate layer according to the second exemplary embodiment.

FIG. 5 is a block diagram illustrating an example of a configuration of a moving image transmission and reception system according to the first exemplary embodiment and the second exemplary embodiment.

FIGS. 6A and 6B each illustrate a temporal hierarchical identifier and each frame rate hierarchical layer according to a conventional example.

FIG. 7 is a block diagram illustrating an example of a configuration of a moving image transmission apparatus 500 according to the first exemplary embodiment.

FIG. 8 is a block diagram illustrating an example of a configuration of hardware of a computer applicable to an image processing apparatus.

FIG. 9 illustrates an example of a shift of a bit rate.

FIG. 10 illustrates an example of a shift of the bit rate according to the first exemplary embodiment.

FIG. 11 illustrates a relationship between a difficulty level of coding and coded data of each frame.

### DESCRIPTION OF THE EMBODIMENTS

Various exemplary embodiments, features, and aspects of the invention will be described in detail below with reference to the drawings. Configurations described in the following exemplary embodiments are merely one example, and the present invention is not limited to the illustrated configurations.

In the following exemplary embodiments, the temporal scalability refers to a technique for constructing the hierarchy in correspondence with the change in the temporal range (scale), i.e., the number of frames per unit time (the frame rate) in the case of the image coding.

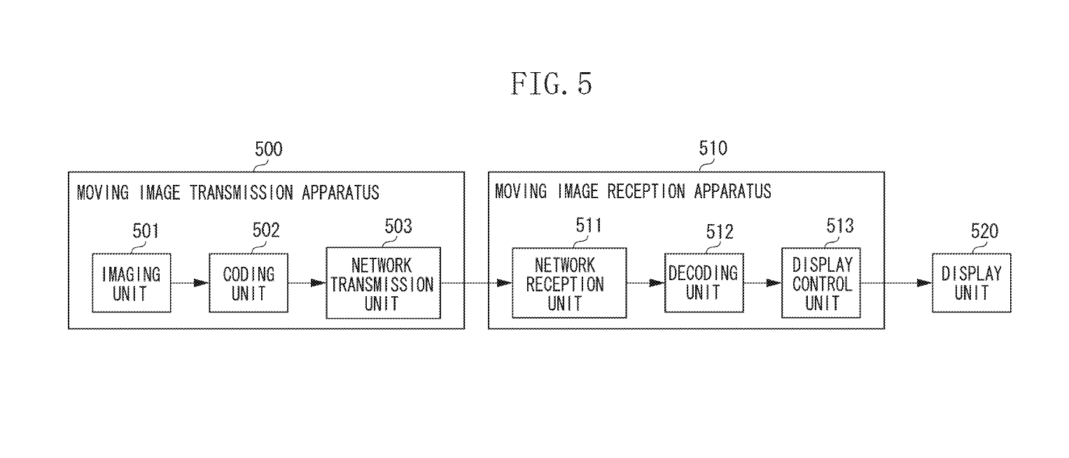

Now, an image processing apparatus according to a first exemplary embodiment will be described with reference to the drawings. First, a configuration of an image processing system according to the present exemplary embodiment will be described with reference to FIG. 5. FIG. 5 is a functional block diagram of a moving image transmission and reception system for transmitting moving image data corresponding to a captured moving image via a communication path, and displaying this moving image data on an apparatus side that receives the moving image data. The moving image transmission and reception system includes a moving image transmission apparatus 500 and a moving image reception apparatus 510. Each of processing units illustrated in FIG. 5 (units 501 to 503 and units 511 to 513) may be constituted by a single physical circuit, or may be constituted by a plurality of circuits (hardware devices). Further, some of the processing units may be combined into a single circuit.

The moving image transmission apparatus 500 is an example of the image processing apparatus according to the present exemplary embodiment. In the moving image transmission apparatus 500, an imaging unit 501, such as a camera, captures an object image to generate moving image data, and outputs the generated moving image data to a coding unit 502. The imaging unit 501 captures an image frame by frame for each predetermined time period to generate moving image data including a plurality of frames. Then, the coding unit 502 compresses the moving image data generated by the imaging unit 501 according to a moving image coding method such as the H. 264 coding method and the HEVC coding method (hereinafter referred to as HEVC) to create coded data, and outputs the created coded data to a network transmission unit 503. The network transmission unit 503 transfers the coded data output from the coding unit 502 to the moving image reception apparatus 510 via the communication path.

Next, in the moving image reception apparatus 510, a network reception unit 511 receives the coded data, and outputs the received coded data to a decoding unit 512. The decoding unit 512 performs decoding (decompressing) processing on the coded data output from the network reception unit 511 to create (reproduce) moving image data. Then, a display control unit 513 performs control so as to display the moving image data created by the decoding unit 512 on a television (TV) reception apparatus, a monitor of a personal computer (PC), a display of a portable apparatus, or the like, as a visible image. The moving image transmission apparatus 500 and the moving image reception apparatus 510 each include a storage device, and advances the processing with use of this storage device as a storage area for various kinds of settings and a buffer area for temporal storage, although the storage device is not illustrated in FIG. 5.

A data amount of the moving image data after being coded by the coding unit 502 varies according to a coding parameter (an image quality setting) used at the time of the coding, such as a quantization parameter (QP). As a value of the QP used at the time of the coding increases, a quantization step increases, whereby the data amount of the coded data after the coding (a coded amount) decreases but the image quality becomes more degraded (reduces). On the other hand, as the value of the QP used at the time of the coding decreases, the image quality becomes less degraded but the data amount of the coded data increases.

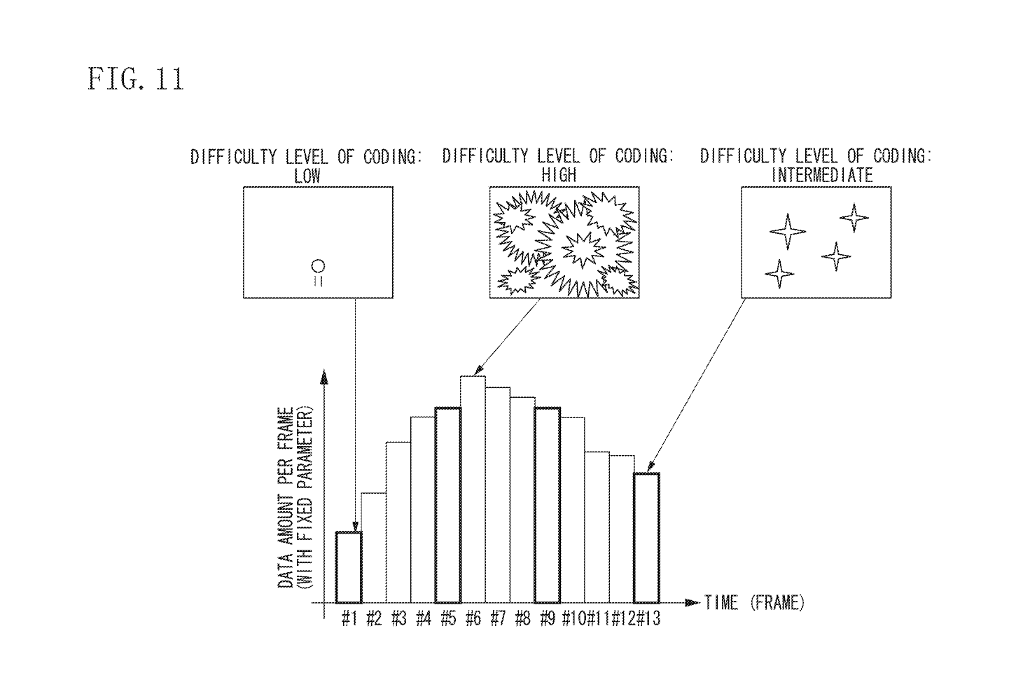

Further, even if a fixed value is set as the coding parameter used at the time of the coding, the coded amount of the moving image still varies according to how easily the moving image can be predicted (a difficulty level of coding), which depends on a content of the moving image that is a coding target. Now, a relationship between the difficulty level of coding and the coded amount when the fixed (same) value is used as the coding parameter will be described with reference to FIG. 11. In a graph illustrated in FIG. 11, a horizontal axis represents a time (a frame number in the moving image that is the coding target), and a vertical axis represents a coded data amount per frame of the moving image. The moving image as the coding target has a low difficulty level of coding at time #1. In this manner, under the same coding parameter conditions, the coded amount of the moving image having the low difficulty level of coding becomes smaller due to a high temporal/spatial correlation between individual pixels therein and thus its easily predictable content. After that, the example illustrated in FIG. 11 indicates that a content of an image of a processing target frame is changing with the passage of a time period during which the moving image is processed by the coding processing, and the difficulty level of coding increases after time #1. Then, FIG. 11 illustrates that the difficulty level of coding is maximized at time #6. In this manner, under the same coding parameter conditions, the coded amount of the moving image having the high difficulty level of coding becomes larger due to a low temporal/spatial correlation between individual pixels therein and thus its difficulty in the prediction. This is followed by a reduction in the difficulty level of coding of the moving image, and also a reduction in the data amount when the moving image is coded with use of the fixed value as the coding parameter, until time #13. In this manner, the difficulty level of coding of the input moving image varies according to a characteristic (a picture) of the moving image, whereby it is necessary to code the moving image while changing the coding parameter according to the change in the characteristic of the moving image to acquire a desired data amount. For example, in a case where a maximum bit rate (a data amount per unit time) is limited in the communication path, the increase in the difficulty level of coding of the moving image raises a necessity of adjusting the coding parameter to keep the bit rate from increasing or allow the bit rate to less increase.

In addition thereto, an actual transmission bit rate (the effective transmission rate) of the communication path may vary according to a congestion state of the communication path, or an environmental factor such as a radio wave condition in a case where the communication path is established via wireless communication. For example, when the effective transmission rate of the communication path is lower than the bit rate of the moving image data after the coding, the moving image transmission apparatus 500 cannot transmit the coded data created by coding the moving image data. This case brings about such a state that a display unit 520, a display of which is controlled by the display control unit 513 on the reception side, can reproduce nothing or reproduce only partially interrupted moving image data until the effective transmission rate of the communication path recovers to the bit rate of the moving image data or a higher bit rate.

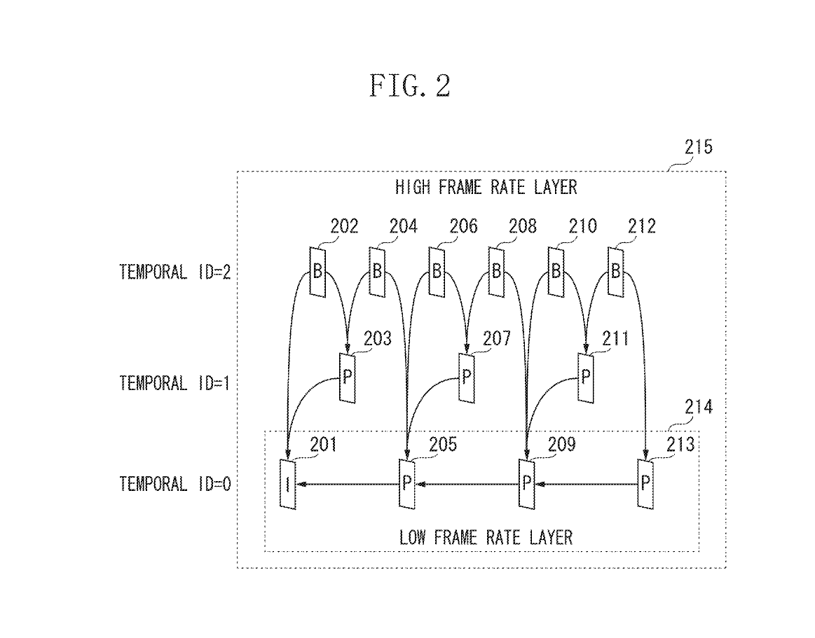

The display unit 520 is provided outside the moving image reception apparatus 510 in FIG. 5, but is not limited thereto and may be mounted inside the moving image reception apparatus 510. Next, a frame structure of the moving image data coded in the present exemplary embodiment will be described with reference to FIG. 2. FIG. 2 illustrates the I frame, the P frame, and the B frame with these frames being sorted into three hierarchical layers (the Temporal IDs=0, 1, and 2). The Temporal ID means the temporal hierarchical identifier (the identifier indicating the temporal hierarchical layer), which is assigned to each frame in the moving image and is the information for identifying each hierarchical layer in the temporal hierarchy. Further, arrows in FIG. 2 each indicate a direction of prediction between frames (i.e., a frame that this arrowed frame refers to for the prediction). In a case where HEVC is employed as the moving image coding method, the prediction can be carried out across a plurality of I frames. Therefore, it is desirable to use an Instantaneous Decoding Refresh (IDR) frame, by which a flexibility of the prediction is limited, for the inter-frame prediction, instead of using the I frame. However, in the present exemplary embodiment, the I frame and the IDR frame will not be treated as different types of frames, and both of them will be referred to as the I frame for the sake of convenience.

As illustrated in FIG. 2, individual frames are arranged in chronological order (in an order of being reproduced), starting from a frame 201 (the I frame, hereinafter abbreviated as the I), followed by a frame 202 (the B frame, hereinafter abbreviated as the B) and a frame 203 (the P frame, hereinafter abbreviated as the P). After that, the frames are arranged in an order of a frame 204(B), a frame 205(P), a frame 206(B), a frame 207(P), a frame 208(B), a frame 209(P), a frame 210(B), a frame 211(P), a frame 212(B), and a frame 213(P). Every frame is provided with the Temporal ID that this frame belongs to. In the present exemplary embodiment, the Temporal ID=2 is assigned to each of the frames 202, 204, 206, 208, 210, and 212. Further, the Temporal ID=1 is assigned to each of the frames 203, 207, and 211, and the Temporal ID=0 is assigned to each of the frames 201, 205, 209, and 213.

Next, processing for selecting a hierarchical layer to classify the moving image data as any of a low frame rate layer and a high frame rate layer separated based on a predetermined temporal hierarchical layer used as a boundary, will be described. In the present exemplary embodiment, a hierarchical layer of a frame group provided with the Temporal ID=0 (a minimum value) is classified as a low frame rate layer 214, and hierarchical layers containing all of the frames 201 to 213 (the Temporal IDs=0, 1, and 2) are classified as a high frame rate layer 215. In the present exemplary embodiment, a threshold value (a temporal hierarchical threshold value) of the Temporal ID for separating the low frame rate layer 214 and the high frame rate layer 215 is set to 0. In other words, the frame provided with the Temporal ID of the threshold value set to 0 or of a smaller value is classified as the low frame rate layer 214. However, the moving image transmission and reception system may perform control so as to classify the frame provided with the Temporal ID smaller than the threshold value set to 1 as the low frame rate layer 214.

In the present exemplary embodiment, the low frame rate layer 214 includes the layer of the single Temporal ID, and the high frame rate layer 215 includes the layers of the three Temporal IDs. However, the frame structure is not limited thereto. In other words, each of the frame rate layers 214 and 215 may include layers of a plurality of Temporal IDs, or may include a layer of a single Temporal ID. For example, the layers of the Temporal ID≦1, and the layer of the Temporal ID=2 illustrated in FIG. 2 may be classified as the low frame rate layer 214 and the high frame rate layer 215, respectively. Regarding a method for determining the threshold value, the threshold value may be specified by a user from outside, may be determined with use of a predetermined algorithm, or may be set to a predetermined value determined in advance. Alternatively, the threshold value for separating each of the frame rate layers 214 and 215 may be determined based on information regarding the effective transmission rate of the communication path between the moving image transmission apparatus 500 and the moving image reception apparatus 510, and/or information regarding a processing capability of the moving image reception apparatus 510. The information regarding the effective transmission rate of the communication path between the moving image transmission apparatus 500 and the moving image reception apparatus 510, and the information regarding the processing capability of the moving image reception apparatus 510 may be information based on a value or values measured by the moving image transmission apparatus 500 and/or the moving image reception apparatus 510. Alternatively, these information pieces may be information based on a value or values measured by an external apparatus (not illustrated) outside the moving image transmission apparatus 500 and the moving image reception apparatus 510.

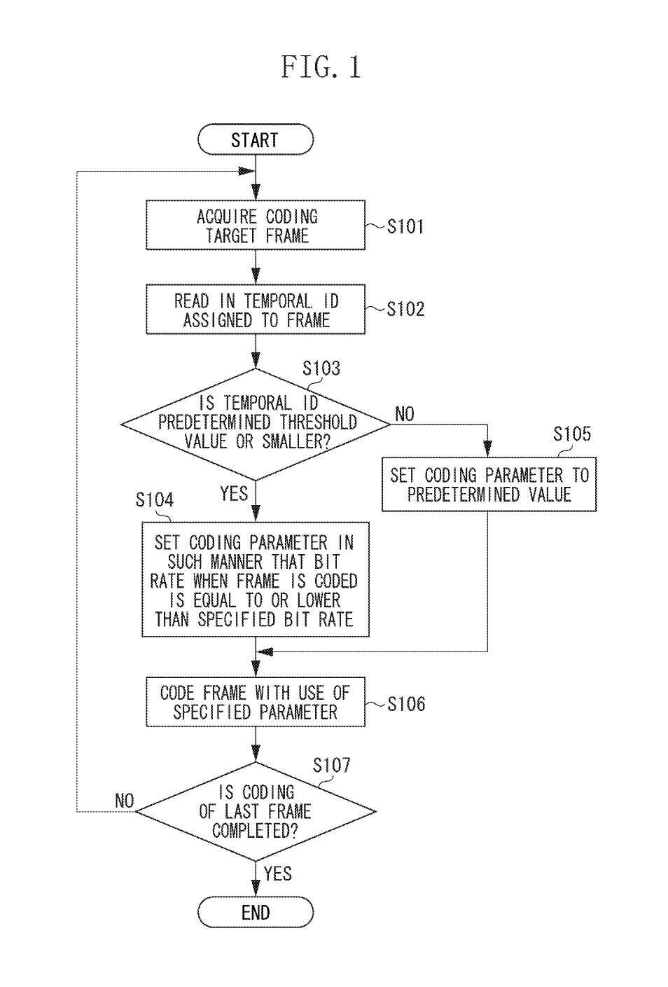

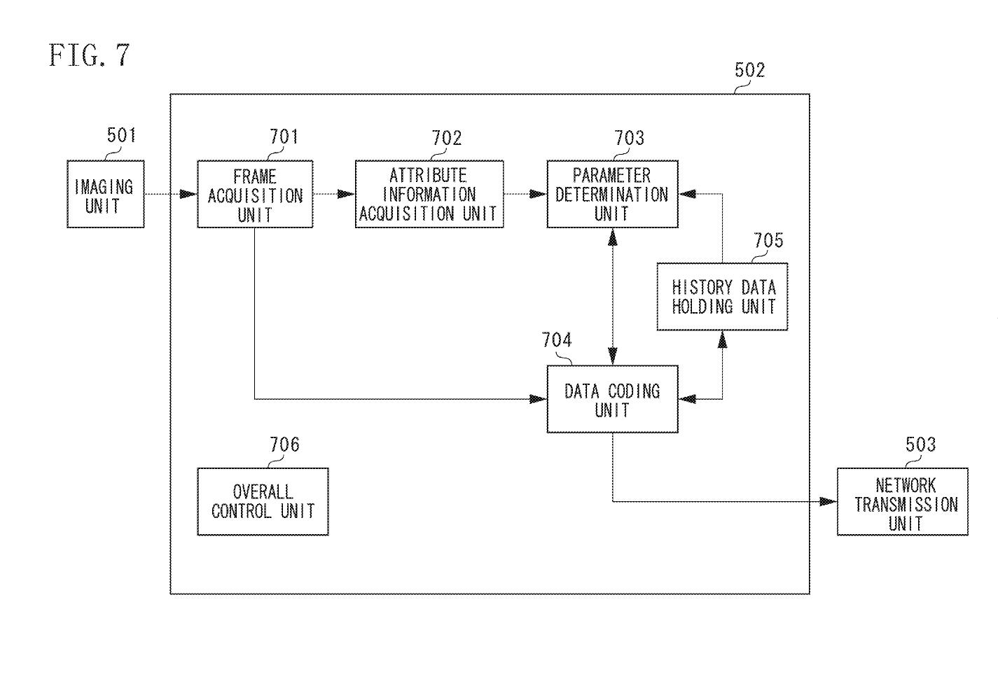

Next, processing for coding the moving image data frame by frame according to the present exemplary embodiment will be described with reference to FIGS. 1 and 7. FIG. 7 is a functional block diagram illustrating processing units of the moving image transmission apparatus 500 according to the present exemplary embodiment. FIG. 1 is a flowchart illustrating a procedure of the coding processing performed by the moving image transmission apparatus 500 according to the present exemplary embodiment. The processing illustrated in the flowchart of FIG. 1 is started after the imaging unit 501 starts shooting the moving image.

Upon the start of the coding processing, in step S101, a frame acquisition unit 701 of the coding unit 502 acquires a coding target frame corresponding to the moving image data captured by the imaging unit 501 from the storage device (not illustrated) of the moving image transmission apparatus 500. The frame acquisition unit 701 may include a buffer capable of holding a plurality of frames. Further, in the present exemplary embodiment, the frame acquisition unit 701 of the coding unit 502 acquires each of the frames 201 to 213 illustrated in FIG. 2 in an order of coding them in the following manner. The frame acquisition unit 701 acquires the frame in an order of the frame 201(I), the frame 203(P), the frame 202(B), the frame 205(P), the frame 204(B), the frame 207(P), the frame 206(B), the frame 209(P), the frame 208(B), the frame 211(P), the frame 210(B), the frame 213(P), and the frame 212(B). In this manner, the order of the frames 201 to 213 acquired by the coding unit 502 is different from the chronological order (the order of being reproduced) illustrated in FIG. 2, and is set to the order in which the frames 201 to 213 are coded. This is because the B frame uses a frame temporally after the B frame as the reference frame, and therefore cannot be coded until this reference frame is coded.

Next, in step S102, an attribute information acquisition unit 702 of the coding unit 502 reads out (acquires) the Temporal ID assigned to the coding target frame acquired in step S101 from the storage device (not illustrated). In step S102, the attribute information acquisition unit 702 may read out the coding target frame in the order of the frames 201 to 213 in the moving image data that are input into the frame acquisition unit 701, but the order in which the attribute information acquisition unit 702 reads out the coding target frame is not limited thereto. In other words, the attribute information acquisition unit 702 may read out the coding target frame in an order established by rearranging the order in which the frames 201 to 213 are input into the frame acquisition unit 701 based on the reproduction order and the coding order of the individual frames 201 to 213 in the moving image data.

Next, in step S103, the attribute information acquisition unit 702 of the coding unit 502 compares (determines) the Temporal ID corresponding to the coding target frame read out in step S102, and the threshold value (the temporal hierarchical threshold value). By this process in step S103, the attribute information acquisition unit 702 can acquire any of the low frame rate layer 214 and the high frame rate layer 215 illustrated in FIG. 2 as a frame group that the coding target frame belongs to based on the Temporal ID of the coding target frame. Then, if the coding unit 502 determines that the Temporal ID is the temporal hierarchical threshold value or smaller in step S103 (YES in step S103), the processing proceeds to step S104. On the other hand, if the coding unit 502 determines that the Temporal ID is larger than the temporal hierarchical threshold value in step S103 (NO in step S103), the processing proceeds to step S105.

In step S104, a parameter determination unit 703 of the coding unit 502 determines the coding parameter to be used in the coding of the coding target frame in such a manner that the bit rate when the coding target frame is coded falls below a predetermined bit rate (a target bit rate) corresponding to the low frame rate layer 214. The value of the quantization parameter to be set to the frame may be specified as the coding parameter, or another parameter that affects the data amount after the coding may be set as the coding parameter. Further, the parameter determination unit 703 may determine the coding parameter to be used in the coding of the coding target frame in such a manner that the bit rate when the coding target frame is coded matches the target bit rate. In other words, the coding unit 502 may perform control in such a manner that the bit rate when the coding target frame is coded matches or falls below the target bit rate.

A history data holding unit 705 stores a past coded history that is related to the coding parameter and corresponding coded amount of the past coded frames derived from a data coding unit 704. Then, the past coded history is used by the parameter determination unit 703 for controlling the bit rate (determination of the coding parameter).

Further, in the present exemplary embodiment, the target bit rate is assumed to be the value based on the effective transmission rate of the communication path when the moving image transmission apparatus 500 transfers the coded frame to the moving image reception apparatus 510 after coding the coding target frame, but is not limited thereto. In other words, the target bit rate may be a value based on a state when the moving image is reproduced on the moving image reception apparatus 510, a value based on a target image quality set as specified by the user, or a value based on a remaining capacity of a buffer (not illustrated) in the moving image reception apparatus 510. Alternatively, the target bit rate may be a value based on a stored amount (a filling rate) of a transmission buffer (not illustrated) included in the network transmission unit 503. The target bit rate may be a value based on at least one of the above-described values, may be a value based on a plurality of conditions, or may be another value than the above-described examples. For example, the target bit rate may be a minimum value of the effective transmission rate based on the transmission state of the communication path, or may be a minimum bit rate that can guarantee the reproduction of the moving image. Alternatively, in the present exemplary embodiment, the parameter determination unit 703 may use the target bit rate determined based on a restriction imposed on the processing unit that receives, decodes, and reproduces the moving image, such as a maximum bit rate decodable by the decoding unit 512.

On the other hand, in step S105, the parameter determination unit 703 of the coding unit 502 sets the coding parameter to be used to code the coding target frame to a predetermined value. In other words, in step S105 in the present exemplary embodiment, the coding unit 502 does not control the bit rate of the frame belonging to the high frame rate layer 215 (does not change the coding parameter thereof), and sets the coding parameter of the coding target frame to the predetermined value. The predetermined value set in step S105 may be any value larger than a coded amount of the frame belonging to the low frame rate layer 214.

Then, in step S106, a data coding unit 704 codes the coding target frame acquired by the frame acquisition unit 701 with use of the coding parameter determined by the parameter determination unit 703 in step S104 or step S105. Then, if the coding target frame is not a last frame in the moving image data (NO in step S107), the processing returns to step S101, and shifts to the processing for coding a next frame. The processes of the above-described individual steps, steps S101 to S106 are repeated until the coding of the last frame in the moving image data is determined to be completed (YES in step S107). If the coding of the last frame is completed (YES in step S107), the processing for coding the moving image data is ended.

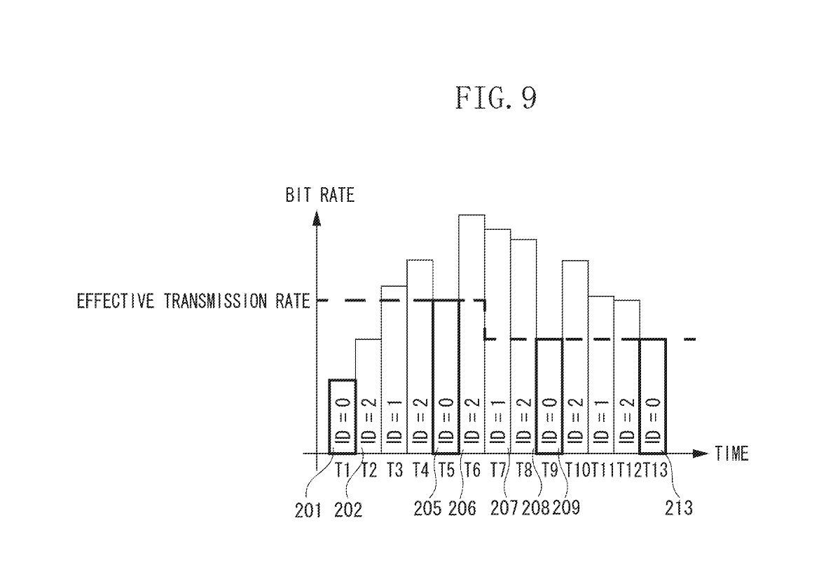

Next, FIG. 9 illustrates an example of a shift of the bit rate controlled according to the flowchart illustrated in FIG. 1. Assume that the moving image data as the coding target has the frame structure illustrated in FIG. 2. In FIG. 9, a horizontal axis represents a reproduction time at which each frame is reproduced, and a vertical axis represents a bit rate when each frame is coded. The frame 201 illustrated in FIG. 2 corresponds to a frame at time T1 illustrated in FIG. 9. Then, the subsequent frames also correspond to frames at times numbered in a matching order, respectively, like the frame 202 illustrated in FIG. 2 corresponding to a frame at time T2 illustrated in FIG. 9 and the frame 213 illustrated in FIG. 2 corresponding to a frame at time T13 illustrated in FIG. 9. In FIG. 9, the Temporal ID is labeled as simply an ID.

For example, the frame 205 at time T5 is provided with the Temporal ID=0 (the temporal hierarchical threshold value=0, or a smaller value). Therefore, in step S103 illustrated in FIG. 1, the parameter determination unit 703 of the coding unit 502 determines YES (YES in step S103). Next, in step S104, the parameter determination unit 703 of the coding unit 502 sets the coding parameter so as to be the designated bit rate, i.e., within the effective transmission rate indicated by a dotted line in FIG. 9 in the present exemplary embodiment.

The frame 206 at a subsequent time, time T6 is provided with the Temporal ID=2 (larger than the temporal hierarchical threshold value=0). Therefore, in step S103, the parameter determination unit 703 determines NO (NO in step S103). Then, in step S105, the parameter determination unit 703 sets the coding parameter to the predetermined value. In other words, the coding unit 502 codes the frame 206 without controlling the bit rate.

The state of the network changes since time T7, and the effective transmission rate reduces. However, the frame 207 at time T7 and the frame 208 at time T8 are provided with the Temporal ID=1 and the Temporal ID=2, respectively, whereby the coding unit 502 codes the frames 207 and 208 without controlling the bit rates in step S105 in a similar manner to the frame 206. The frame 209 at a subsequent time, time T9 is provided with the Temporal ID=0, whereby the parameter determination unit 703 sets the coding parameter in such a manner that the bit rate when the frame 209 is coded matches or falls below the effective transmission rate (which reduces to a smaller value at this time than the effective transmission rate at time T5) in step S104 in a similar manner to the frame 205.

By the processing indicated by the flowchart illustrated in FIG. 1, the moving image transmission and reception system performs control so as to prevent the bit rate when the frame is coded from exceeding the effective transmission rate for the frame belonging to the hierarchical layer having the Temporal ID of the temporal hierarchical threshold value or a smaller value, as illustrated in FIG. 9. Further, the moving image transmission and reception system permits the bit rate when the frame is coded to exceed the effective transmission rate, and does not control the bit rate, for the frame belonging to the hierarchical layer having the Temporal ID larger than the temporal hierarchical threshold value (the high frame rate layer 215). Then, the moving image transmission and reception system can keep the frame having the bit rate exceeding the effective transmission rate when the frame is coded from being transmitted by the moving image transmission apparatus 500 or reproduced by the moving image reception apparatus 510, according to the state of the communication path and/or the processing status of the moving image reception apparatus 510. More specifically, the network transmission unit 503 assigns a priority level corresponding to the Temporal ID to the data of each of the frames 201 to 213 after the coding according to a desired network transmission method. Normally, data transmitted via a network is treated dataset by dataset that is called a packet, and each packet has header information indicating the priority level. Transmission and reception of the data, i.e., supply and acceptance of the packet in the network is carried out in descending order of priority of a packet (i.e., from a packet having a higher priority level). The network transmission unit 503 and the network reception unit 511 control the transmission and the reception of the packet according to the assigned priority level, which allows the transmission of the frame data to be controlled according to the state of the communication path. In other words, this method allows the transmission and the reception of the frame provided with a low priority level (a large Temporal ID) to be stopped or reduced under such a situation that the network is congested. With this method, the moving image transmission and reception system can appropriately select the transmittable and receivable frame rate layer according to the state of the communication path and/or the processing status on the reception side, while the bit rate when the frame is coded exceeds the effective transmission rate locally (the frame belonging to the high frame rate layer 215).

In the present exemplary embodiment, the moving image transmission and reception system determines whether to transmit the frame belonging to the high frame rate layer 215 by the moving image transmission apparatus 500 according to the state of the communication path and/or the processing status on the reception side, but the transmission of the frame belonging to the high frame rate layer 215 is not limited thereto. In other words, the moving image transmission apparatus 500 may control a timing at which the moving image transmission apparatus 500 transmits this frame according to the state of the communication path and/or the processing status on the reception side. For example, the moving image transmission apparatus 500 may perform control so as to transmit the frame belonging to the high frame rate layer 215 at a timing when the communication path is not congested more than a predetermined degree and/or a timing when there is some room in the processing status on the reception side. Further, the moving image reception apparatus 510 may determine whether to receive the frame belonging to the high frame rate layer 215, or may determine whether to decode and reproduce this frame after receiving it. Further, the moving image reception apparatus 510 may control a timing at which the moving image reception apparatus 510 receives the frame belonging to the high frame rate layer 215 according to the congestion state of the communication path and/or the processing status on the reception side.

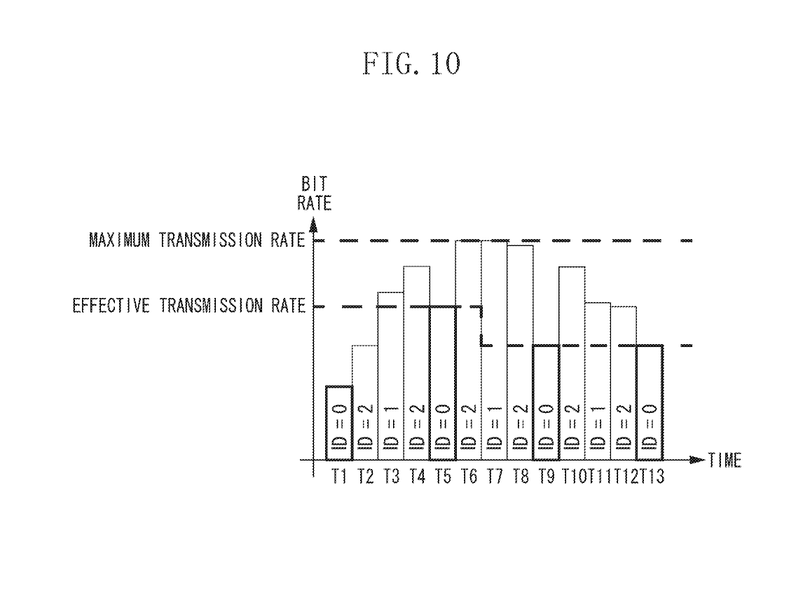

In the present exemplary embodiment, the coding unit 502 is configured to refrain from controlling the bit rate of the frame belonging to the high frame rate layer 215 in step S105 illustrated in FIG. 1, but the handling of the bit rate at this time is not limited thereto. For example, the coding unit 502 sets the coding parameters to the predetermined value without controlling the bit rates at times T6 to T8 illustrated in FIG. 9, but may set a maximum value of the bit rate (a maximum transmission rate) and perform control so as to prevent the bit rates from exceeding this value as illustrated in FIG. 10. In an example illustrated in FIG. 10, a larger value (the maximum transmission rate) than a maximum bit rate for the low frame rate layer 214 (the effective transmission rate) is set as the maximum bit rate for the high frame rate layer 215. Then, in step S105, the coding unit 502 controls the parameter so as to allow the bit rate for the high frame rate layer 215 to be equal to or lower than the maximum transmission rate. In other words, the coding unit 502 also controls the bit rate for the high frame rate layer 215 based on the larger value than the bit rate for the low frame rate layer 214. One possible example of the maximum transmission rate at this time is an ideal upper limit value of the network communication path or the like. Controlling the bit rate in this manner allows the bit rate for the high frame rate layer 215 to be equal to or lower than a value with which the transmission can be ensured when the network is in an excellent state.

By the present exemplary embodiment, the moving image transmission and reception system can realize the scalable bit rate control and frame rate control of the coded moving image data in consideration of the effective transmission rate of the communication path and the Temporal ID.

By the present exemplary embodiment, the moving image transmission and reception system can select the frame rate layer (the high frame rate layer 215 or the low frame rate layer 214) that the coding target frame belongs to based on the value of the Temporal ID, and then transmit and reproduce this frame.

Further, in the present exemplary embodiment, the moving image transmission apparatus 500 can control the bit rate by determining the coding parameter to be used at the time of the coding based on the frame rate layer 214 or 215 that the coding target frame belongs to. This bit rate control allows the moving image transmission apparatus 500 to appropriately select the transmittable and receivable frame rate layer according to the effective transmission rate of the communication path between the moving image transmission apparatus 500 and the moving image reception apparatus 510, and the processing capability of the moving image reception apparatus 510.

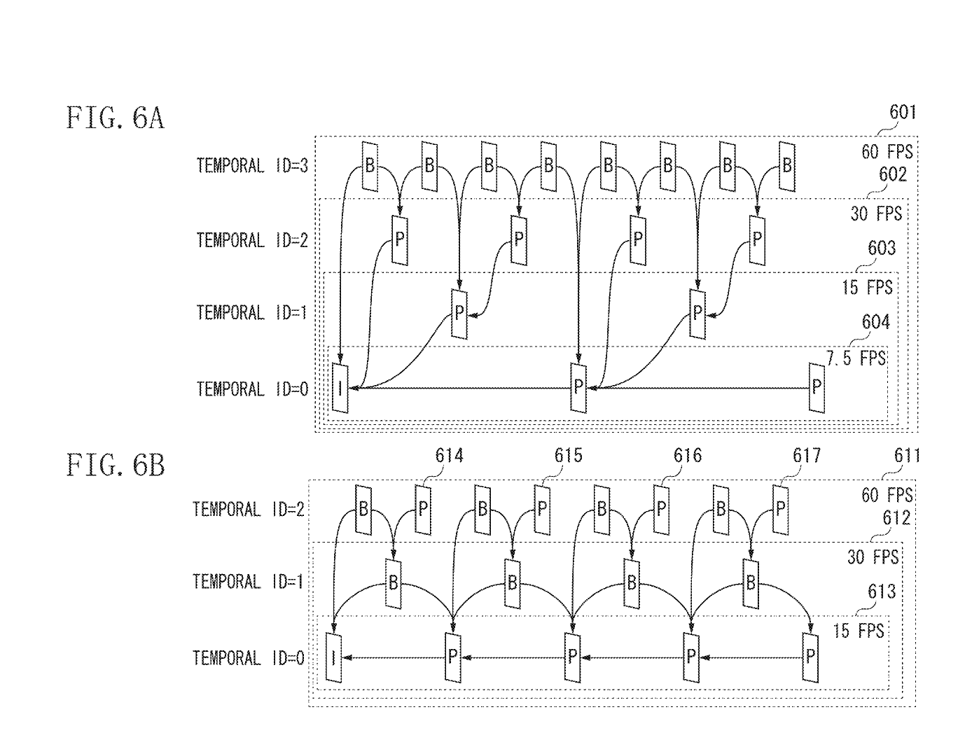

Further, the following problem may arise, in a case where the moving image transmission and reception system removes the frames while assigning a same priority level thereto, as long as their frame types are the same, even if they belong to the hierarchical layers corresponding to the different Temporal IDs, without performing the control like the present exemplary embodiment. For example, if the moving image transmission and reception system removes the B frame belonging to the hierarchical layer of the Temporal ID=1 and the B frame belonging to the hierarchical layer of the Temporal ID=2 illustrated in FIG. 6B while assigning a same priority level thereto, the frame rates of 30 frames/second (FPS) and 60 FPS cannot be acquired with respect to the Temporal IDs=1 and 2, respectively. Further, the number of priority levels is limited by the number of kinds of the frame types (the frame prediction methods), whereby it is difficult to control the bit rate and the frame rate to a desired bit rate and a desired frame rate, respectively. However, by the present exemplary embodiment, the moving image transmission and reception system can control the bit rate by setting the coding parameter based on the Temporal ID and the state of the communication path. As a result, the moving image transmission and reception system can control the bit rate to the desired bit rate while controlling the frame rate to the desired frame rate in consideration of the Temporal ID. For example, when the bit rate of the coding target frame likely exceeds the effective transmission rate of the communication path, the moving image transmission and reception system can control the bit rate by adjusting the coding parameter based on the Temporal ID even without cutting off all of the frames provided with the low priority level.

In the present exemplary embodiment, the coding unit 502 is assumed to always code each frame contained in the high frame rate layer 215 with use of the constant coding parameter. However, the method for controlling the bit rate for the high frame rate layer 215 is not limited thereto. More specifically, in step S105, the parameter determination unit 703 may set the coding parameter in a different manner, as long as the coding parameter is set in such a manner that the bit rate of each frame contained in the high frame rate layer 215 becomes higher than the bit rate of each frame contained in the low frame rate layer 214. Further, the parameter determination unit 703 may determine the coding parameter of each frame contained in the high frame rate layer 215 based on the bit rate when the best effort is achieved at the communication path between the moving image transmission apparatus 500 and the moving image reception apparatus 510 (the maximum transmission rate). Alternatively, the parameter determination unit 703 may, for example, acquire a bit rate sufficient to maintain a quality (an image quality) of the moving image by a predetermined method, and set the coding parameter of each frame contained in the high frame rate layer 215 based on the acquired bit rate.

Further, in the present exemplary embodiment, the network transmission unit 503 determines the frame rate layer to be set as the transmission target according to the effective transmission rate of the communication path between the moving image transmission apparatus 500 and the moving image reception apparatus 510. More specifically, the network transmission unit 503 performs control so as to transmit only the low frame rate layer 214 without transmitting the high frame rate layer 215 under such a situation that the effective transmission rate of the communication path reduces. However, the method for controlling the transmission of the moving image data is not limited thereto. For example, the moving image transmission and reception system may be configured in such a manner that the network transmission unit 503 constantly transmits the frames as far as the high frame rate layer 215, and the network reception unit 511 selects and receives only the frame belonging to the low frame rate layer 214 based on the Temporal ID of the received frame. In other words, the network transmission unit 503 may be configured to transmit the frames as far as the high frame rate layer 215 regardless of the effective transmission rate of the communication path. Further, the network transmission unit 503 may add attribute information regarding the priority level based on the Temporal ID to the moving image data (the packet) to be transmitted, and then transmit the moving image data to the moving image reception apparatus 510. For example, the priority level based on the Temporal ID may be determined in such a manner that the high priority level is assigned to the frame provided with the Temporal ID of a small value, and the low priority level is assigned to the frame provided with the Temporal ID of a large value.

Further, in the present exemplary embodiment, the temporal hierarchical threshold value=0 is set as the predetermined threshold value compared to the Temporal ID corresponding to the coding target frame in step S103 illustrated in FIG. 1. However, the predetermined threshold value used in step S103 is not limited thereto, and may be a different threshold value from this temporal hierarchical threshold value.

Further, the present exemplary embodiment has been described assuming that it employs the control method based on the effective transmission rate of the communication path, but what the control method is based on is not limited to the effective transmission rate of the communication path. In other words, the moving image transmission and reception system may measure a data amount received by the moving image reception apparatus 510 per predetermined time period to feed back the measured data amount to the moving image transmission apparatus 500, and cause the moving image transmission apparatus 500 to determine the coding parameter based thereon. Alternatively, the moving image transmission and reception system may measure a data amount of the coded data output by the moving image transmission apparatus 500 per predetermined time period or calculate a data amount of the transmitted coded data from a capacity of the transmission buffer, and determine the coding parameter based thereon.

In the above-described first exemplary embodiment, each of the frames 201 to 213 in the moving image data is allocated to any of the two layers, the low frame rate layer 214 and the high frame rate layer 215. In a second exemplary embodiment, the moving image transmission and reception system controls the bit rate of each frame, in a case where, with use of frame rate layers divided into three or more layers, each frame in the moving image data is allocated to any of these three or more frame rate layers. The configuration illustrated in FIG. 5 can be used as a configuration of the moving image transmission and reception system according to the present exemplary embodiment in a similar manner to the first exemplary embodiment, and therefore a description of the configuration according to the present exemplary embodiment will be omitted here.

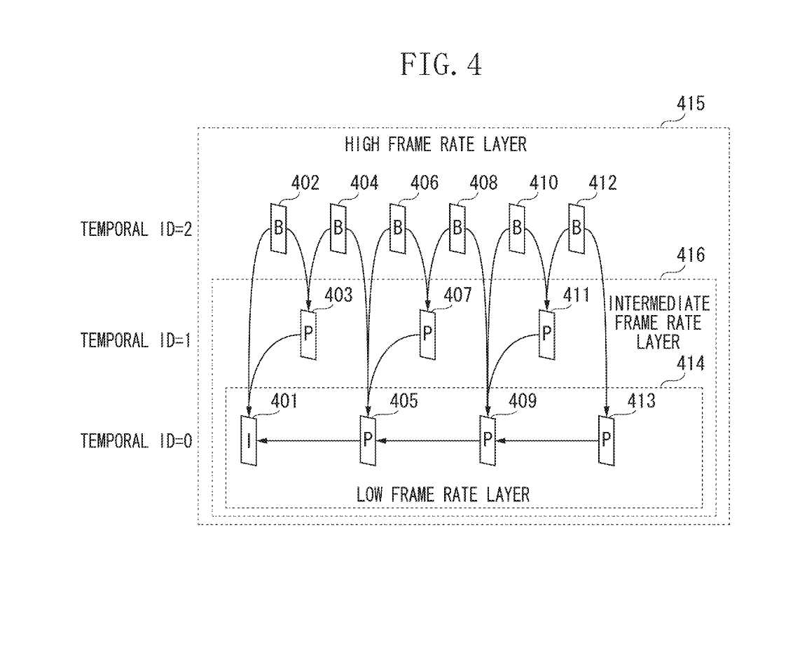

First, a frame structure of the moving image data in the present exemplary embodiment will be described with reference to FIG. 4. Individual frames 401 to 413 illustrated in FIG. 4 are similar to the respective corresponding individual frames 201 to 213 illustrated in FIG. 2, and therefore descriptions thereof will be omitted here. Similarly, a low frame rate layer 414 and a high frame rate layer 415 are also similar to the low frame rate layer 214 and the high frame rate layer 215 illustrated in FIG. 2, respectively, and therefore descriptions thereof will be omitted here. In the present exemplary embodiment, an intermediate frame rate layer 416, which is a hierarchical layer of a frame group having the Temporal IDs=0 and 1, is used in addition to the low frame rate layer 414 and the high frame rate layer 415. Further, in the present exemplary embodiment, 0 is set as a first threshold value (a first temporal hierarchical threshold value) of the Temporal ID for distinguishing the low frame rate layer 414. Further, 1 is set as a second threshold value (a second temporal hierarchical threshold value) of the Temporal ID for distinguishing the intermediate frame rate layer 416. In other words, the frame provided with the Temporal ID of the first threshold value (0) or a smaller value is classified as the low frame rate layer 414, and the frame provided with the Temporal ID larger than the first threshold value, and equal to or smaller than the second threshold value (1) is classified as the intermediate frame rate layer 416.

In the present exemplary embodiment, there is only the single intermediate frame rate layer 416, and the individual frames 401 to 413 are allocated to the three frame rate layers 414 to 416, but the frame structure is not limited thereto. The individual frames 401 to 413 may be allocated to four or more frame rate layers with use of a plurality of intermediate frame rate layers. For example, as illustrated in FIG. 6A, the two layers, the frame group 602 (the Temporal ID≦2) and the frame group 603 (the Temporal ID≦1) may be used as the intermediate frame rate layers. Regarding a method for determining the threshold values, the threshold values may be determined based on values specified by the user from outside, or may be determined based on a predetermined algorithm. Alternatively, predetermined values determined in advance may be used as the threshold values.

In the present exemplary embodiment, the coding unit 502 codes each of the low frame rate layer 414 and the intermediate frame rate layer 416 at a fixed bit rate according to a target bit rate. More specifically, in the present exemplary embodiment, the coding unit 502 codes the low frame rate layer 414 at a fixed bit rate based on a first target bit rate, and the intermediate frame rate layer 416 at a fixed bit rate based on a second target bit rate. In the present exemplary embodiment, the first target bit rate set to the low frame rate layer 414, and a third target bit rate set to the high frame rate layer 415 are similar to the target bit rates in the first exemplary embodiment, respectively, and therefore descriptions thereof will be omitted here.

A higher value than the target bit rate of the low frame rate layer 414 (the first target bit rate), which realizes a lower frame rate than a frame rate of the intermediate frame rate layer 416, is used as the second target bit rate set to the intermediate frame rate layer 416. Further, a lower value than the target bit rate (the third target bit rate) of the high frame rate layer 415, which realizes a higher frame rate than the frame rate of the intermediate frame rate layer 416, is used as the second target bit rate set to the intermediate frame rate layer 416. In other words, in the present exemplary embodiment, the individual target bit rates set to the individual frame rate layers 414 to 416 are determined so as to establish a relationship of the first target bit rate<the second target bit rate<the third target bit rate. Specific set values of the individual target bit rates are not limited to any particular values, and one possible example thereof is incrementing the set values in a stepwise fashion in an order of the first target bit rate, the second target bit rate, and the third target bit rate, like setting them to 10 Mbps, 20 Mbps, and 40 Mbps, respectively.

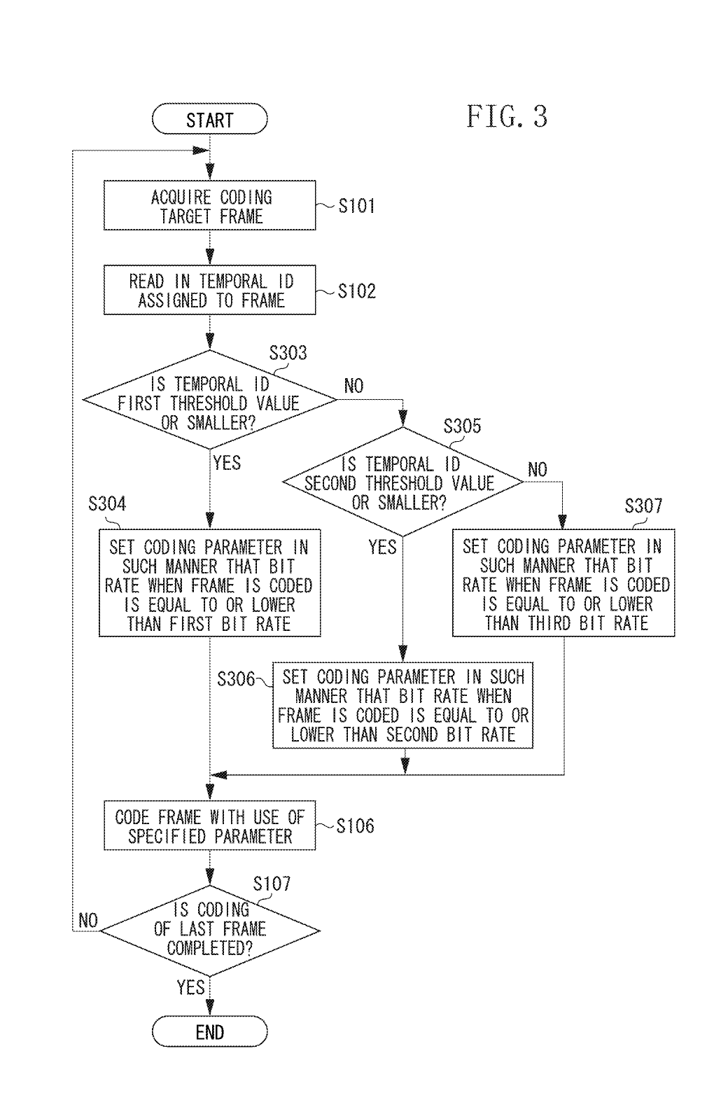

Next, processing for coding the moving image data frame by frame, which is performed by the moving image transmission apparatus 500 according to the present exemplary embodiment, will be described with reference to a flowchart illustrated in FIG. 3. Processes of individual steps S101, S102, S106, and S107 illustrated in FIG. 3 are similar to steps S101, S102, S106, and S107 in the first exemplary embodiment, respectively, and therefore descriptions thereof will be omitted here. Further, the processing indicated by the flowchart illustrated in FIG. 3 according to the present exemplary embodiment is started after the imaging unit 501 starts capturing the moving image, in a similar manner to FIG. 1.

After each of the steps S101 and S102 is performed, in step S303, the attribute information acquisition unit 702 of the coding unit 502 compares the Temporal ID corresponding to the coding target frame read out in step S102, and the first threshold value (temporal hierarchical threshold value). With this process of step S303, the attribute information acquisition unit 702 can determine whether the coding target frame belongs to the low frame rate layer 414 illustrated in FIG. 4 based on the Temporal ID of the coding target frame. If the attribute information acquisition unit 702 determines that the Temporal ID of the coding target frame is the first threshold value or smaller at this time (YES in step S303), the coding unit 502 determines that the coding target frame is a frame belonging to the low frame rate layer 414 and the processing proceeds to step S304. On the other hand, if the attribute information acquisition unit 702 determines that the Temporal ID of the coding target frame is larger than the first threshold value (NO in step S303), the coding unit 502 determines that the coding target frame is a frame belonging to a layer other than the low frame rate layer 414 and the processing proceeds to step S305.

In step S304, the parameter determination unit 703 of the coding unit 502 determines the coding parameter to be used in the coding of the coding target frame in such a manner that the bit rate when the coding target frame is coded falls below the first target bit rate specified in advance.

Further, in step S305, the attribute information acquisition unit 702 determines that the coding target frame belongs to a frame rate layer other than the low frame rate layer 414, and compares the Temporal ID of the coding target frame and the second threshold value (temporal hierarchical threshold value). If the attribute information acquisition unit 702 determines that the Temporal ID of the coding target frame is the second threshold value or smaller at this time (YES in step S305), the coding unit 502 determines that the coding target frame is a frame belonging to the intermediate frame rate layer 416, and the processing proceeds to step S306. On the other hand, if the attribute information acquisition unit 702 determines that the Temporal ID of the coding target frame is larger than the second threshold value (NO in step S305), the coding unit 502 determines that the coding target frame is a frame belonging to the high frame rate layer 415 and the processing proceeds to step S307.

In step S306, the parameter determination unit 703 of the coding unit 502 determines the coding parameter to be used in the coding of the coding target frame in such a manner that the bit rate when the coding target frame is coded falls below the second target bit rate specified in advance. Further, in step S307, the parameter determination unit 703 of the coding unit 502 determines the coding parameter to be used in the coding of the coding target frame in such a manner that the bit rate when the coding target frame is coded falls below the third target bit rate specified in advance. The value of the quantization parameter to be set to the frame may be specified as the coding parameter, or another parameter that affects the data amount after the coding may be set as the coding parameter.

Then, in step S106, the data coding unit 704 codes the coding target frame acquired by the frame acquisition unit 701 with use of the coding parameter determined by the parameter determination unit 703 in any of steps S304, S306, and S307. Then, the coding unit 502 repeats the processes of the above-described individual steps, steps S101, S102, S303 to S307, and S106 until the coding of the last frame in the moving image data is determined to be completed in step S107 (YES in step S107).

In the present exemplary embodiment, the moving image transmission and reception system determines whether to transmit the frame belonging to the high frame rate layer 415 or the intermediate frame rate layer 416 by the moving image transmission apparatus 500 according to the state of the communication path and/or the processing status on the reception side, but the transmission of the frame belonging to the high frame rate layer 415 or the intermediate frame rate layer 416 is not limited thereto. In other words, the moving image transmission apparatus 500 may control a timing at which the moving image transmission apparatus 500 transmits this frame according to the state of the communication path and/or the processing status on the reception side. For example, the moving image transmission apparatus 500 may perform control so as to transmit the frame belonging to the high frame rate layer 415 or the intermediate frame rate layer 416 at the timing when the communication path is not congested more than the predetermined degree and/or the timing when there is some room in the processing status on the reception side. Further, the moving image reception apparatus 510 may determine whether to receive the frame belonging to the high frame rate layer 415 or the intermediate frame rate layer 416, or may determine whether to decode and reproduce this frame after receiving it. Further, the moving image reception apparatus 510 may control a timing at which the moving image reception apparatus 510 receives the frame belonging to the high frame rate layer 415 or the intermediate frame rate layer 416 according to the congestion state of the communication path and/or the processing status on the reception side.

By the present exemplary embodiment, the moving image transmission and reception system can realize the adaptive bit rate control and frame rate control of the coded moving image data in consideration of the effective transmission rate of the communication path and the Temporal ID. Further, by the present exemplary embodiment, the moving image transmission and reception system can realize the bit rate control according to effective transmission rates different from one another among individual network paths connecting the transmission unit and a plurality of reception units.

By the present exemplary embodiment, the moving image transmission and reception system can select the frame rate layer that the coding target frame belongs to (the high frame rate layer 415, the intermediate frame rate layer 416, or the low frame rate layer 414) based on the value of the Temporal ID, and then transmit and reproduce this frame.

Further, in the present exemplary embodiment, the moving image transmission apparatus 500 can control the bit rate by determining the coding parameter to be used at the time of the coding based on the frame rate layer 414, 415, or 416 that the coding target frame belongs to. This bit rate control allows the moving image transmission apparatus 500 to appropriately select the transmittable and receivable frame rate layer according to the effective transmission rate of the communication path between the moving image transmission apparatus 500 and the moving image reception apparatus 510, and the processing capability of the moving image reception apparatus 510.

Further, by the present exemplary embodiment, the moving image transmission and reception system can control the bit rate by setting the coding parameter based on the Temporal ID and the state of the communication path. This bit rate control allows the moving image transmission and reception system to control the bit rate to the desired bit rate while controlling the frame rate to the desired frame rate in consideration of the Temporal ID.

In the present exemplary embodiment, the coding unit 502 sets the coding parameter of each frame contained in the high frame rate layer 415 in such a manner that the bit rate when the frame is coded matches or falls below the third target bit rate. However, the setting of the coding parameter of this frame is not limited thereto. More specifically, the parameter determination unit 703 may determine the coding parameter of each frame contained in the high frame rate layer 415 based on the bit rate when the best effort is achieved at the communication path between the moving image transmission apparatus 500 and the moving image reception apparatus 510 (the maximum transmission rate). Alternatively, the parameter determination unit 703 may, for example, acquire the bit rate sufficient to maintain the quality (the image quality) of the moving image by a predetermined method, and set the coding parameter of each frame contained in the high frame rate layer 415 with use of the acquired bit rate as the third target bit rate.

Further, the present exemplary embodiment has been described assuming that it employs the first bit rate control, the second bit rate control, and the third bit rate control corresponding to the three frame rate layers 414, 415, and 416. However, the bit rate control is not limited thereto. For example, a third threshold value is additionally prepared in FIG. 3 (the first threshold value<the second threshold value<the third threshold value), and the process of step S307 is further branched. More specifically, a frame rate layer and a bit rate corresponding thereto can be added by setting the coding parameter in such a manner that the bit rate when the frame is coded matches or falls below the third bit rate if the Temporal ID is the third threshold value or smaller, and matches or falls below a fourth bit rate if the Temporal ID is larger than the third threshold value. Similarly, additionally preparing the Temporal ID having a larger value and a threshold value corresponding thereto in FIG. 3 allows the number of frame rate layers and the number of (controllable) bit rates corresponding thereto to further increase. For example, in a case where a plurality of moving image reception apparatuses 510 exists for the single moving image transmission apparatus 500, and is connected to different networks, the effective transmission rates and maximum transmission rates of the individual networks may be different from one another. In such a case, the increase in the number of hierarchical layers of frame rates allows the moving image transmission and reception system to perform control corresponding to the bit rate that should be satisfied for each of them.

Further, in the present exemplary embodiment, the network transmission unit 503 determines the frame rate layer to be set as the transmission target according to the effective transmission rate of the communication path between the moving image transmission apparatus 500 and the moving image reception apparatus 510. More specifically, the network transmission unit 503 performs control so as to transmit the intermediate frame rate layer 416 or the low frame rate layer 414 without transmitting the high frame rate layer 415 under such a situation that the effective transmission rate of the communication path reduces. However, the control of the transmission of the moving image data is not limited thereto. For example, the moving image transmission and reception system may be configured in such a manner that the network transmission unit 503 constantly transmits the frames as far as the high frame rate layer 415, and the network reception unit 511 selects and receives only the low frame rate layer 414 based on the Temporal ID of the received frame. Further, the network transmission unit 503 may add the attribute information regarding the priority level based on the Temporal ID to the moving image data (the packet) to be transmitted, and then transmit this moving image data to the moving image reception apparatus 510. For example, the network transmission unit 503 may transmit the moving image data after adding the attribute of the high priority level to the frame provided with the Temporal ID of a small value, and the attribute of the low priority level to the frame provided with the Temporal ID of a large value as the priority level based on the Temporal ID.

Further, in the present exemplary embodiment, the first threshold value=0 is set as the predetermined threshold value compared to the Temporal ID corresponding to the coding target frame in step S303 illustrated in FIG. 3. However, the predetermined threshold value used in step S303 is not limited thereto, and may be a different threshold value from this first threshold value. Similarly, the second threshold value=1 is set as the predetermined threshold value compared to the Temporal ID corresponding to the coding target frame in step S305 illustrated in FIG. 3. However, the predetermined threshold value used in step S305 is not limited thereto, and may be a different threshold value from this second threshold value.

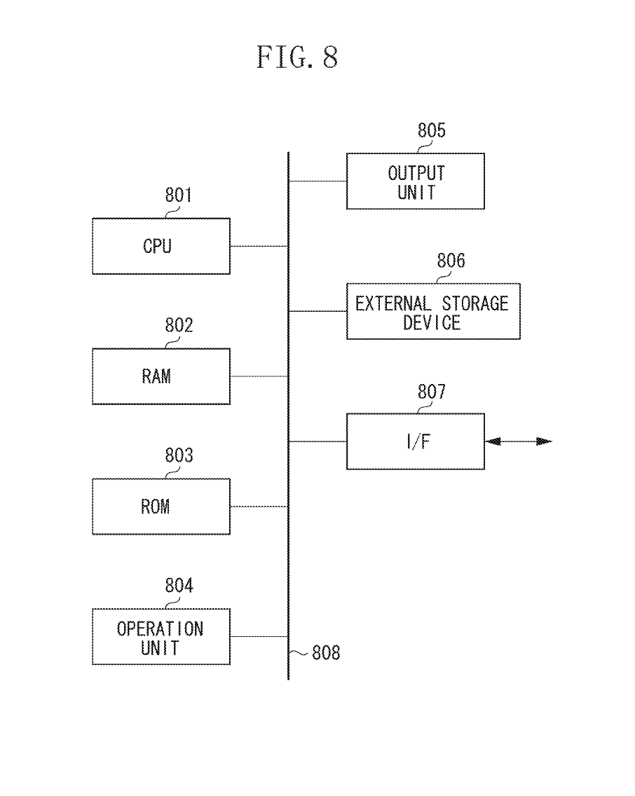

The above-described exemplary embodiments have been described assuming that each of the processing units illustrated in FIG. 5 is realized by the hardware. However, the processing performed by each of the processing units illustrated in these drawings may be realized by a computer program. In the following description, a third exemplary embodiment will be described with reference to FIG. 8. FIG. 8 is a block diagram illustrating an example of a configuration of hardware of a computer applicable to the image processing system according to each of the above-described exemplary embodiments.

A central processing unit (CPU) 801 controls the entire computer with use of a computer program and data stored in a random access memory (RAM) 802 and/or a read only memory (ROM) 803, and performs each of the processing procedures that have been described above assuming that the image processing system according to each of the above-described exemplary embodiments performs them. This means that the CPU 801 functions as each processing unit illustrated in FIG. 5.

The RAM 802 has an area for temporarily storing a computer program and data loaded from an external storage device 806, data acquired from outside via an interface (I/F) 807, and the like. Further, the RAM 802 has a work area to be used when the CPU 801 performs various kinds of processing. In other words, the RAM 802, for example, can be allocated as a picture memory, and provide other various kinds of areas as necessary.

The ROM 803 stores setting data of this computer, a boot program, and the like. An operation unit 804 includes a keyboard, a mouse, and the like, and can input various kinds of instructions into the CPU 801 by being operated by a user of the present computer. An output unit 805 displays a result of the processing performed by the CPU 801. Further, the output unit 805 includes, for example, a liquid crystal display.

The external storage device 806 is a mass-capacity information storage device represented by a hard disk drive device. The external storage device 806 stores an operating system (OS), and a computer program for allowing the CPU 801 to realize the function of each of the units illustrated in FIG. 5. Further, the external storage device 806 may store each image data piece as the processing target.

The computer program and the data stored in the external storage device 806 are loaded into the RAM 802 according to control by the CPU 801 when necessary, and are processed as the target of the processing performed by the CPU 801. A network such as a local area network (LAN) and the Internet, another apparatus such as a projection apparatus and a display apparatus can be connected to the I/F 807, and the computer can acquire and transmit various kinds of information via this I/F 807. A bus 808 connects the above-described individual units to one another.

The CPU 801 mainly control an operation realized by the above-described components by performing the above-described flowcharts.

### Other Exemplary Embodiments

In each of the above-described first to third exemplary embodiments, the moving image transmission and reception system permits the bit rate when the frame is coded to exceed the effective transmission rate only for the high frame rate layer 215 or 415. However, the bit rate control is not limited thereto. For example, the moving image transmission and reception system may permit the bit rate when the frame is coded to exceed the effective transmission rate only for the intermediate frame rate layer 416. In this case, a similar effect can be achieved by controlling the bit rate(s) so as to prevent the bit rate(s) from exceeding the effective transmission rate for the frame(s) belonging to the other frame rate layer(s).

Further, by each of the above-described first to third exemplary embodiments, the moving image transmission and reception system codes the frame belonging to the low frame rate layer 214 or 414 and the frame(s) belonging to the other frame rate layer(s) 215, or 415 and/or 416 so as to prevent the bit rate from exceeding the effective transmission rate, and so as to permit the bit rate(s) to locally exceed the effective transmission rate, respectively. This coding method also allows the moving image transmission and reception system to easily select the transmittable and receivable frame rate layer according to the effective transmission rate of the communication path and/or the processing capability on the reception side. Then, this coding method allows the moving image transmission and reception system to transmit the frame belonging to the low frame rate layer 214 or 414 while reducing a delay from the transmission to the reproduction (prioritizing a real-time performance), although the image quality changes due to the bit rate control performed in such a manner that the bit rate matches or falls below the effective transmission rate. On the other hand, this coding method allows the moving image transmission and reception system to transmit the frame(s) belonging to the other frame rate layer(s) 215, or 415 and/or 416 while permitting the delay but preventing or reducing the degradation of the image quality of the moving image data, by coding this or these frame(s) so as to permit the bit rate(s) to exceed the effective transmission rate but prevent the bit rate(s) from exceeding the maximum transmission rate. In other words, the moving image transmission and reception system may refrain from transmitting the frame(s) belonging to the other frame rate layer(s) 215, or 415 and/or 416 depending on the state of the communication path, and perform control so as to transmit this or these frame(s) when there is some room in the communication path. In this manner, by each of the above-described first to third exemplary embodiments, the moving image transmission and reception system can transmit the moving image data with the reduced delay while ensuring that a minimum frame rate is maintained even when the state of the communication path changes, and select the frame rate according to the state of the communication path.

In each of the above-described first to third exemplary embodiments, the moving image transmission apparatus 500 illustrated in FIG. 5 includes the imaging unit 501, the coding unit 502, and the network transmission unit 503, but the configuration thereof is not limited thereto. In other words, the imaging unit 501 and the coding unit 502 may be separated from each other, and different devices may include these individual processing units.

In each of the above-described first to third exemplary embodiments, each of the processing units of the coding unit 502 illustrated in FIG. 7 may be constituted by a single physical circuit, or may be constituted by a plurality of circuits. Further, each of the processing units of the coding unit 502 illustrated in FIG. 7 may be controlled by a single overall control unit 706, or these processing units may be controlled by a plurality of control units. Further, the overall control unit 706 may control the processing unit (e.g., the imaging unit 501 and the network transmission unit 503) outside the coding unit 502, or the overall control unit 706 provided outside the coding unit 502 may control each of the processing units of the coding unit 502.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s).

The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-174495, filed Aug. 28, 2014, which is hereby incorporated by reference herein in its entirety.

What is claimed is:

1. An image processing apparatus configured to code a frame included in a moving image with use of a temporal hierarchal layer, the image processing apparatus comprising:
an acquisition unit configured to acquire information regarding the temporal hierarchal layer corresponding to the frame of a coding target; and
a coding unit configured to code the frame of the coding target with use of a first coding parameter that causes a bit rate after the frame is coded to be equal to or lower than a first bit rate corresponding to the temporal hierarchal layer acquired by the acquisition unit, or a second coding parameter that causes the bit rate after the frame is coded to match a second bit rate higher than the first bit rate, based on the information regarding the temporal hierarchal layer acquired by the acquisition unit.

2. The image processing apparatus according to claim 1, wherein the coding unit codes the frame of the coding target with use of the first coding parameter if the temporal hierarchal layer corresponding to the frame of the coding target is lower than a predetermined value, and codes the frame of the coding target with use of the second coding parameter if the temporal hierarchal layer corresponding to the frame of the coding target is higher than the predetermined value.

3. The image processing apparatus according to claim 1, further comprising a second acquisition unit configured to acquire a coding parameter preset to the frame of the coding target,
wherein the coding unit codes the frame of the coding target with use of the preset coding parameter acquired by the second acquisition unit as the second coding parameter, if the temporal hierarchal layer corresponding to the cording target frame is higher than the predetermined value.

4. The image processing apparatus according to claim 1,
wherein the first coding parameter is a parameter based on an effective transmission rate, which is an actual bit rate of a communication path via which the coded frame is transmitted, and
wherein the coding unit codes the frame of the coding target with use of the first coding parameter that causes the bit rate after the frame is coded to be equal to or lower than the effective transmission rate, if the temporal hierarchal layer corresponding to the frame of the coding target is lower than the predetermined value.

5. The image processing apparatus according to claim 4,
wherein the second coding parameter is a parameter based on a maximum bit rate limited on the communication path via which the coded frame is transmitted, and
wherein the coding unit codes the frame of the coding target with use of the second coding parameter that causes the bit rate after the frame is coded to be larger than the effective transmission rate, and to be equal to or lower than the maximum bit rate, if the temporal hierarchal layer corresponding to the frame of the coding target is higher than the predetermined value.

6. The image processing apparatus according to claim 1, further comprising a transmission unit configured to transmit coded data after the frame of the coding target is coded while prioritizing a frame corresponding to a lower temporal hierarchal layer than the predetermined value over a frame corresponding to a higher temporal hierarchal layer than the predetermined value among a plurality of frames included in the moving image.

7. The image processing apparatus according to claim 1, wherein the coding parameter includes a quantization parameter.

8. An image processing method for coding a frame included in a moving image with use of a temporal hierarchal layer, the image processing method comprising:
acquiring information regarding the temporal hierarchal layer corresponding to the frame of a coding target; and
coding the frame of the coding target with use of a first coding parameter that causes a bit rate after the frame is coded to be equal to or lower than a first bit rate corresponding to the acquired temporal hierarchal layer, or a second coding parameter that causes the bit rate after the frame is coded to be equal to a second bit rate higher than the first bit rate, based on the information regarding the acquired temporal hierarchal layer.

9. A non-transitory computer-readable storage medium storing a program for causing a computer to execute processing, the program comprising:
computer-executable instructions that code a frame included in a moving image with use of a temporal hierarchal layer;
computer-executable instructions that acquire information regarding the temporal hierarchal layer corresponding to the frame of a coding target; and
computer-executable instructions that code the frame of the coding target with use of a first coding parameter that causes a bit rate after the frame is coded to be equal to or lower than a first bit rate corresponding to the acquired temporal hierarchal layer, or a second coding parameter that causes the bit rate after the frame is coded to be equal to a second bit rate higher than the first bit rate, based on the information regarding the acquired temporal hierarchal layer.
